(19) United States
(12) Patent Application Publication
(10) Pub. No.: US 2012/0056407 A1
(43) Pub. Date: Mar. 8, 2012

(54) Hydraulically Operated Gooseneck Trailer and Latch Assembly

(76) Inventors: David Lee Trowbridge, Wilton, CA (US); Douglas Glen Murray, Lodi, CA (US)

(21) Appl. No.: 12/874,937

(22) Filed: Sep. 2, 2010

(51) Int. Cl. B62D 53/06

(52) U.S. Cl. 280/441.2

(57) ABSTRACT

Gooseneck trailer having a horizontally extending deck with a plurality of longitudinally extending frame members including outer side rails which extend along opposite sides of the deck, lower gooseneck beams rigidly connected the outer deck rails by couplings that can be selectively engaged and disengaged, elongated upper gooseneck beams pivotally connected to the lower beams, with one end of each of the upper beams being pivotally connected to a pulling vehicle, operating cylinders connected between the upper and lower beams for raising and lowering the lower beams and the trailer deck when the upper beams are connected to the pulling vehicle, and latches for locking the upper and lower beams in different positions relative to each other. Each of the latches has first and second elongated ratchet blocks disposed side-by-side with mating teeth along confronting edges of the two blocks and upper and lower ends of the blocks being pivotally connected to respective ones of the beams for movement longitudinally with the beams and laterally toward and away from each other, and actuators for pivoting the blocks to bring the teeth on the two blocks into and out of engagement with each other to lock the beams in the different positions.

### BACKGROUND OF THE INVENTION

1. Field of Invention

This invention pertains generally to trailers for carrying large, heavy loads and, more particularly, to a trailer having a hydraulically operated gooseneck and latch assembly.

2. Related Art

Trailers for transporting construction equipment and other large, heavy loads typically have elongated decks supported toward the rear by ground engaging wheels, with means toward the fronts of the decks for connecting the trailers to tractors or other pulling vehicles. The connection is commonly made with a gooseneck which can be detached from the deck to allow the equipment to be loaded onto the deck from the front. The gooseneck can either be a rigid structure that must be raised and lowered manually, or it can have a hydraulically operated lifting structure built into it.

With a rigid gooseneck, the raising and lowering of the gooseneck and the trailer deck is commonly done with the pulling vehicle, and one example of a trailer with a rigid gooseneck is shown in FIGS. 1-4 and described in greater detail in U.S. Pat. No. 3,326,572. That trailer has an elongated deck 16 with ground supporting wheels 17 at the rear and a gooseneck 18 which connects the deck to a pulling vehicle 19. The gooseneck is detachably connected to the deck by a coupling assembly 21 on each side of the deck and detachably connected to the fifth wheel 22 of the pulling vehicle in the conventional manner.

The gooseneck is disconnected from the front of the deck so that equipment can be loaded onto or off of the trailer by first disconnecting the gooseneck from the fifth wheel and driving the vehicle slowly forward while the front end of the gooseneck slides down a ramp 23 at the rear of the vehicle, lowering the front of the trailer toward the ground, as shown in FIG. 2. Once the front end of the deck is resting on the ground, the coupling between the gooseneck and the deck is disconnected, and the vehicle is backed up to engage the gooseneck with the ramp and raise it up into position to be reconnected to the fifth wheel, as illustrated in FIG. 3. Once the gooseneck is reconnected to the fifth wheel, the vehicle is driven forward to pull the gooseneck away from the deck, as shown in FIG. 4.

The gooseneck is reconnected to the deck by backing the vehicle toward the deck, with the gooseneck attached to the fifth wheel. Once the rear portion of the gooseneck is engaged with the deck, as shown in FIG. 3, the gooseneck is disconnected from the fifth wheel, and the vehicle is driven forward to lower the gooseneck into full engagement with the mounting pads on the deck, as shown in FIG. 2. The coupling between the gooseneck and the deck is then reconnected, and the truck is backed toward the deck to raise the gooseneck and deck to the running position. The gooseneck is then reconnected to the fifth wheel to secure the trailer in the running position.

This procedure is time consuming and can be difficult to perform on slick or icy surfaces where the pulling vehicle may not be able to get sufficient traction to lift the gooseneck up the ramp and/or the trailer may slide away due to the forces exerted on it during the ramping process.

Hydraulically operated goosenecks eliminate the need to move the pulling vehicle back and forth while disconnecting and reconnecting the gooseneck, and they can be used in situations where a manually operated gooseneck cannot. However, they are also subject to certain limitations and disadvantages.

The lifting mechanism must, for example, bear a portion of its own weight in addition to the weight of the deck and load carried by the deck, and there must be some means for locking the mechanism securely and safely in its different operating positions.

Another problem with hydraulic goosenecks heretofore provided is that they have not been wide enough for the loads the trailers are carrying. Goosenecks usually connect to the front end portions of the main beams in the deck frame. These beams extend along the sides of the deck of most trailers, although heavier trailers may have additional beams between the outer pair. When a gooseneck is connected to the inner pair of beams, as is commonly done, it may be narrower than the load and can provide a path for the load to be propelled into the cab of the pulling vehicle in the event that a sudden stop causes the load to break loose from the deck and be hurled forward.

### OBJECTS AND SUMMARY OF THE INVENTION

It is, in general, an object of the invention to provide a new and improved *.

Another object of the invention is to provide a * of the above character which *.

It is, in general, an object of the invention to provide a new and improved hydraulically operated gooseneck trailer and latch assembly.

Another object of the invention is to provide a gooseneck trailer and latch assembly of the above character which overcomes the limitations and disadvantages of trailers heretofore provided.

These and other objects are achieved in accordance with the invention by providing a gooseneck trailer having a horizontally extending deck with a plurality of longitudinally extending frame members including outer side rails which extend along opposite sides of the deck, lower gooseneck beams rigidly connected the outer deck rails by couplings that can be selectively engaged and disengaged, elongated upper gooseneck beams pivotally connected to the lower beams, with one end of each of the upper beams being pivotally connected to a pulling vehicle, operating cylinders connected between the upper and lower beams for raising and lowering the lower beams and the trailer deck when the upper beams are connected to the pulling vehicle, and latches for locking the upper and lower beams in different positions relative to each other.

Each of the latches has first and second elongated ratchet blocks disposed side-by-side with mating teeth along confronting edges of the two blocks and upper and lower ends of the blocks being pivotally connected to respective ones of the beams for movement longitudinally with the beams and laterally toward and away from each other, and actuators for pivoting the blocks to bring the teeth on the two blocks into and out of engagement with each other to lock the beams in the different positions.

### BRIEF DESCRIPTION OF THE DRAWINGS

FIG. 1 is a side elevational view of a gooseneck trailer of the prior art.

FIGS. 2-4 are fragmentary operational views of the gooseneck trailer of FIG. 1.

FIG. 5 is a side elevational view of one embodiment of a gooseneck trailer with a hydraulically operated gooseneck assembly according to the invention.

FIG. 6 is a top plan view of the gooseneck assembly in the embodiment of FIG. 5.

FIGS. 7 and 8 are enlarged, fragmentary vertical sectional views of the gooseneck assembly in the embodiment of FIG. 5.

FIG. 9 is an enlarged, side elevational view, partly broken away, of a portion of the gooseneck assembly in the embodiment of FIG. 5.

FIG. 10 is an exploded elevational view of the latch assembly in the embodiment of FIG. 5.

FIGS. 11-14 are operational views of the latch assembly shown in FIG. 10.

FIGS. 15-18 are operational views of the gooseneck assembly in the embodiment of FIG. 5.

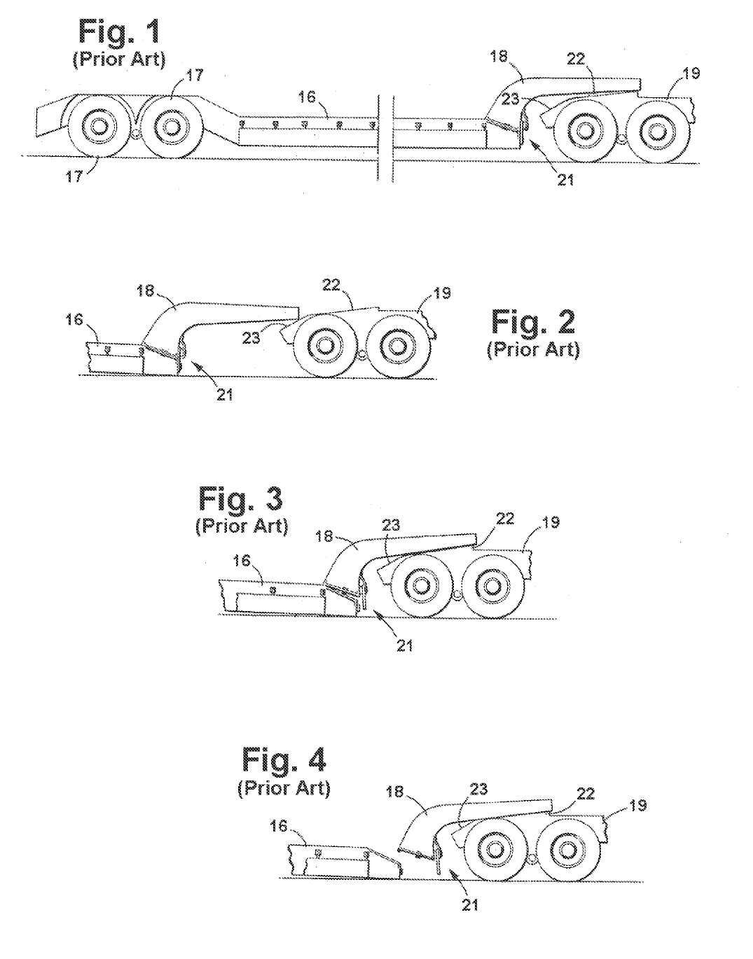

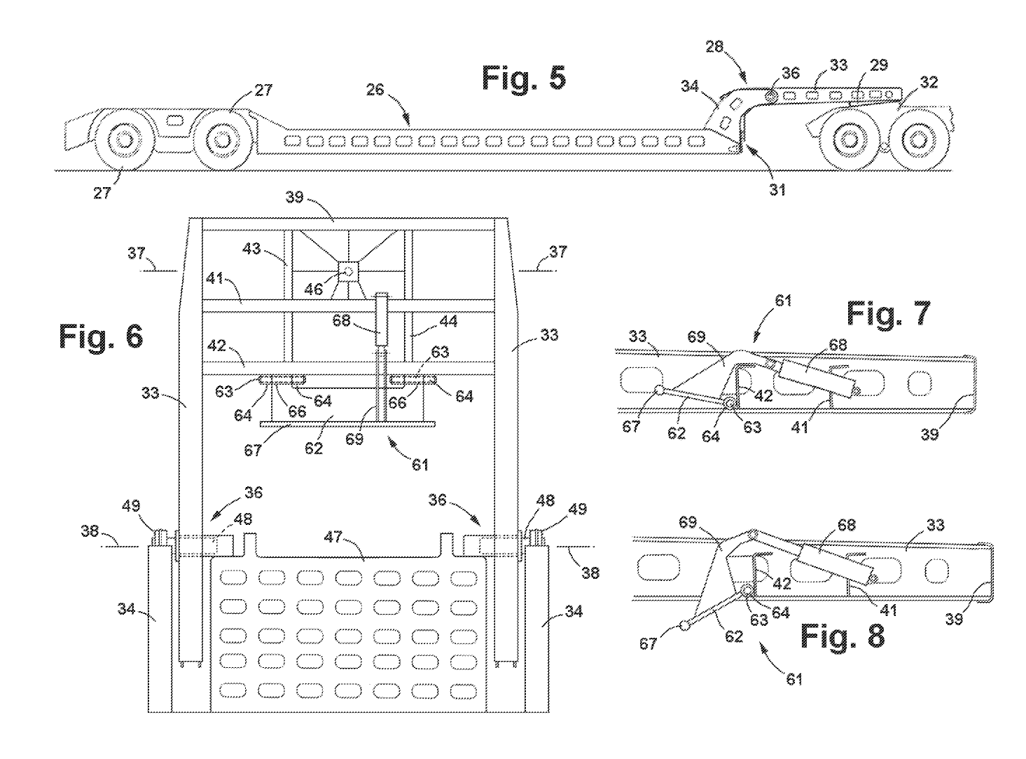

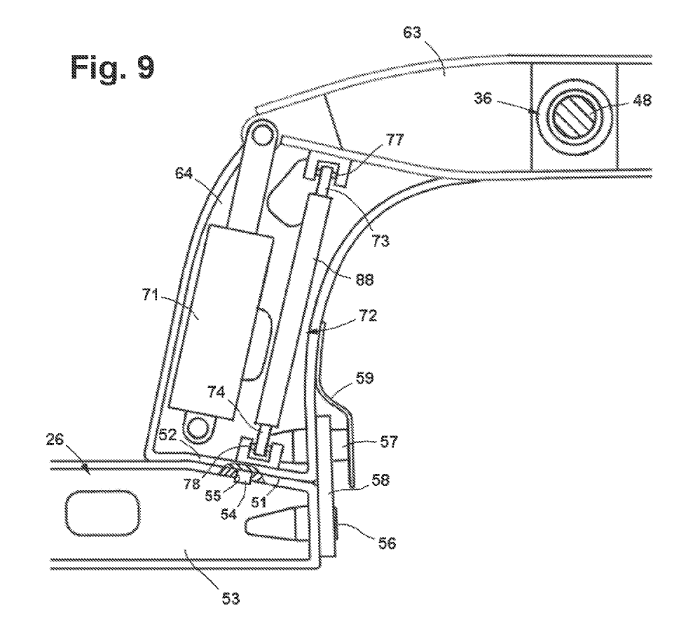

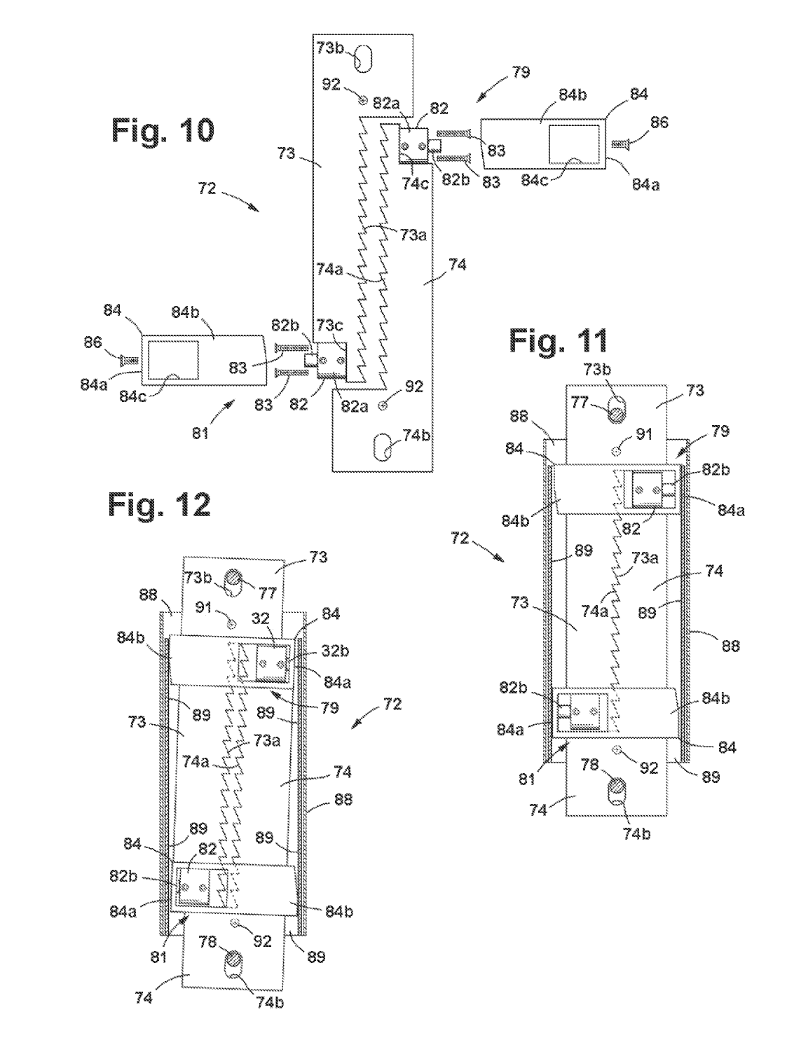

### DETAILED DESCRIPTION

As illustrated in FIG. 6, the trailer has an elongated deck 26 with ground supporting wheels 27 at the rear and a gooseneck assembly 28 which connects the deck to a pulling vehicle 29. The gooseneck is detachably connected to the deck by a coupling assembly 31 on each side of the deck and detachably connected to the fifth wheel 32 of the pulling vehicle.

Gooseneck assembly 28 has upper and lower beams 33, 34 which are connected together by axially aligned pivots 36 on opposite sides of the trailer. Upper beams 33 extend in a generally horizontal direction and toward their front ends are pivotally connected to the fifth wheel of the pulling vehicle for movement about a horizontally extending axis 37 parallel to the axis 38 of pivots 36. Lower beams 34 are curved in a manner resembling the neck of a goose, with the lower or rear ends of those beams being detachably connected to trailer deck 16 and the upper or forward ends being pivotally connected to the upper beams.

Upper beams 33 are I-beams which extend almost the entire length of the gooseneck assembly, with cross members 39, 41, and 42 extending between the forward portions beams and inner frame members 43, 44 extending between the cross members to form a rigid upper framework. The fifth wheel connector 46 is attached to cross members 39, 41 and inner frame members 43, 44 toward the front of the framework.

Lower beams 34 are also I-beams, and they are part of a rigid lower framework that includes a rear apron 47 with a curvature corresponding to that of the beams. The beams are positioned toward the sides of the trailer in alignment with the beams at the sides of the deck, unlike trailers of the prior art in which the gooseneck beams are aligned with and connected to inner beams.

Pivots 36 include cylindrical pins or axles 48 which extend in an outward direction from the web portions of upper beams 33 and are received in bearings 49 affixed to the web portions of lower beams 34. In connecting the upper and lower beams together, these pivots also connect the entire upper and lower frameworks together for rotation relative to each other about axis 38.

The lower surfaces 51 of the rear portions of lower beams 34 and the upper surfaces 52 of the front portions of the side frame members 53 of deck 16 are inclined downwardly and forwardly to form mating surfaces which abut against each other when the gooseneck is attached to the deck. Generally rectangular lugs or teeth 54 extend downwardly from the lower surfaces of beams 34 and are received in openings or sockets 55 in frame members 53. These lugs help to guide the mating surfaces into proper alignment as well as providing longitudinal and lateral stability for the connection between the gooseneck and the deck.

The gooseneck and deck are connected together in load supporting relationship by coupling assemblies 31 which include coupling pins 56, 57 and a link 58. Pins 56 extend longitudinally from the forward ends of deck beams 53, and pins 57 extend from the front flanges of the upright portions of gooseneck beams 34 along axes spaced from and parallel to the axes of pins 56. The gooseneck pins are longer than the deck pins, and the front ends of the gooseneck pins are supported by straps 59 affixed to the front sides of the vertical portions of the gooseneck beams.

Links 58 are slidably mounted on the gooseneck pins for movement between forward and aft positions relative to the pins. In the aft position, the links encircle both the gooseneck pins 57 and the deck pins 56 and lock the abutting surfaces of the beams rigidly together, thereby connecting the gooseneck to the deck. In the forward position, the links hang from the gooseneck pins, disengaged from the deck pins, and the gooseneck is disconnected from the deck.

The gooseneck assembly also includes a stand 61 for supporting the upper framework in a predetermined position when the assembly is disconnected from the trailer deck. This stand includes a hinge plate 62 which is pivotally connected to cross member 42 by hinge pins 63 and ferrules 64, 66 attached to the cross member and plate, with a bar 67 attached to the outer edge of the plate for engagement with the frame of the pulling vehicle. An operating cylinder 68 is connected to an actuating arm 69 affixed to the plate for moving the stand between the retracted position shown in FIG. 7 and the extended position shown in FIG. 8.

Hydraulic operating cylinders 71 are pivotally connected between the rear end portions of upper beams 33 and the base portions of lower beams 33 for rotating the beams about pivot axis 38. With the cylinders connected in this manner, extending them swings the rear end portions of the upper and lower beams away from each other and increases the angle between them, whereas retracting the cylinders rotates the end portions toward each other and decreases the angle between them. With the front ends of the upper beams pivotally connected to the pulling vehicle and the base portions of the lower beams connected to the trailer deck, extending the cylinders and increasing the angle between the beams raises the rear ends of the two beams and the front of the trailer deck, whereas retracting the cylinders and decreasing the angles between the beams lowers the rear ends of the beams and the front end of the deck.

A latch mechanism 72 is also connected between the upper and lower beams on each side of the trailer for locking the beams in different rotational positions relative to each other. Each of these mechanisms includes a pair of elongated ratchet blocks 73, 74 disposed side-by-side, with mating teeth 73a, 74a along confronting edges of the two blocks. One end of block 73 is pivotally connected to upper beam 33 for movement about a first axis, and the opposite end of block 74 is pivotally connected to lower beam 74 for movement about a second axis substantially parallel to the first. The connections between the blocks and the beams are made by pivot pins 77, 78 which are affixed to the beams and pass through elongated openings 73b, 74b in the blocks, with the elongation of the openings accommodating a skewing of the pins relative to each other as the beams move to different positions.

Actuators 79, 81 are provided for pivoting the ratchet blocks about the pins to bring the teeth on the two blocks into and out of engagement with each other. The actuators include double acting pneumatic or hydraulic operating cylinders 82 mounted in notched area 73c, 74c at the free ends of the ratchet blocks. The bodies 82a of the cylinders are secured to the blocks by mounting screws 83, and push bar bars 84 are attached to the armatures or pistons 82b of the cylinders by mounting screws 86. The push bars are generally U-shaped, with base sections 84a attached to the cylinders and arms 84b which extend from the base sections along opposite sides of the ratchet blocks. Since the diameter of the cylinders is greater than the thickness of the ratchet blocks, windows or openings 84a are provided in the push bar arms to accommodate the portions of the cylinders that extend beyond the surfaces of the blocks.

The ratchet blocks and actuators are enclosed within a pair of generally rectangular telescoping boxes or tubes 88, 89, with the upper end portion of outer box 88 being pivotally connected to upper ratchet block 73 by a screw 91 spaced a short distance below pivot pin 77 and the lower end portion of inner box 89 being pivotally connected to upper ratchet block 74 by a screw 92 spaced a short distance above pivot pin 79.

When the armatures of the cylinders are extended as shown in FIG. 11, the bases of push bars 84 bear against opposite side walls of inner box 89, pushing the two ratchet blocks toward each other to engage the teeth. When the armatures are retracted, the free ends of push bar arms 84b bear against the side walls of the inner box, as illustrated in FIG. 12, and push the two blocks away from each other to disengage the teeth.

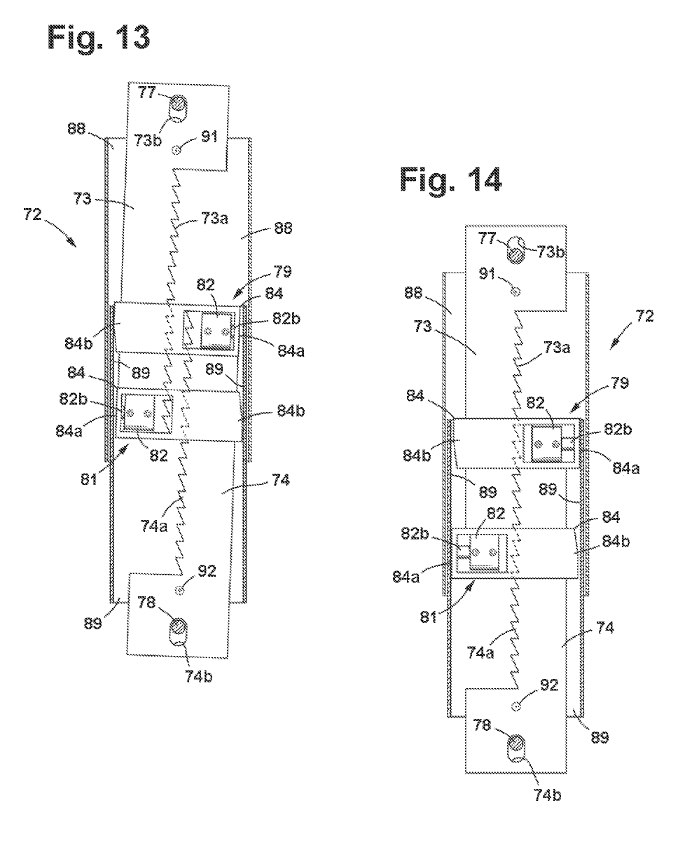

FIG. 13 shows the latch mechanism in a disengaged, extended position with the free ends of the push bar arms engaging the side walls of the box, and FIG. 14 shows the mechanism locked in the extended position with the bases of the push bars engaging the walls of the boxes and the teeth on the upper portion of the lower block and the lower portion of the upper block engaged with each other.

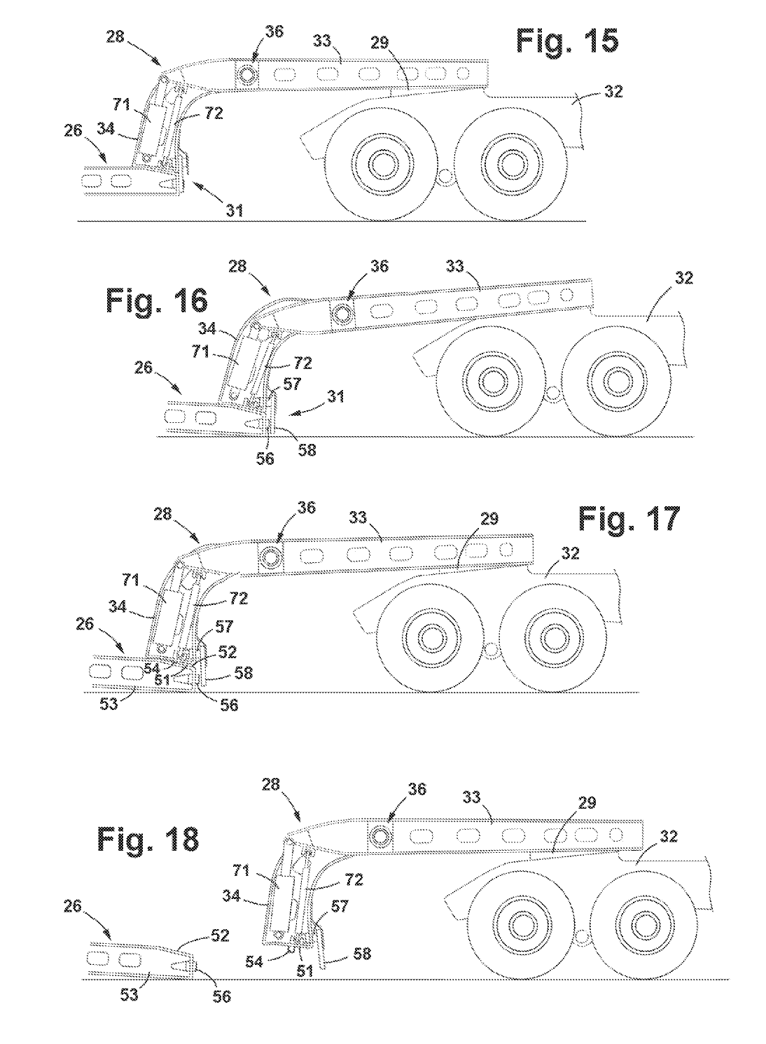

Operation and use of the gooseneck assembly is as follows. In the normal running position, the gooseneck assembly 28 is connected both to the trailer deck 26 and to the fifth wheel 29 of the pulling vehicle 32, as shown in FIG. 15. In this position, couplings 31 are engaged to hold the gooseneck and deck rigidly together, hydraulic cylinders 71 are extended so that the deck is in a generally horizontal position, and latch mechanisms 72 are engaged to lock upper and lower arms in position.

To disconnect the gooseneck assembly from the deck, latch mechanisms 72 are actuated to disengage the teeth and permit ratchet blocks 73, 74 to move with the beams to which they are connected, and hydraulic cylinders 71 are retracted to lower the front end of trailer deck 26 to the ground, with upper beams 33 rotating in a downward direction relative to the pulling vehicle and lower beans 34 rotating in a downward direction relative to the upper beams. With the deck on the ground, coupling links 58 are slid forward to disengage them from the coupling pins 56 on the deck, as shown in FIG. 16. The cylinders are then extended enough to tilt the mounting surfaces 51 of the lower beams on the mounting surfaces 52 of deck beams 53, as shown in FIG. 17, to disengage lugs 54 from slots 55 and free the gooseneck for movement away from the deck. Once the lugs are free of the slots, the latch mechanisms are once again engaged, stand 61 is lowered into engagement with the pulling vehicle to support the upper beams, and the gooseneck is pulled away from the deck, as shown in FIG. 18.

Reconnecting the gooseneck to the trailer deck is essentially the reverse of disconnecting it. The gooseneck attached to the pulling vehicle is positioned so that the mounting surfaces 51 of lower beams 34 are aligned with the mounting surfaces 52 of deck beams 53, stand 61 is disengaged from the pulling vehicle, the latch mechanisms are disengaged, and the hydraulic cylinders are retracted to lower the beams and bring the mounting surfaces into contact with each other, with lugs 54 being received in slots 55, as shown in FIGS. 16 and 17. Coupling links 58 are then slid back into engagement with deck pins 56 to lock the gooseneck and deck together, and the hydraulic cylinders are extended to raise the gooseneck beams and the front of the deck back to the running position shown in FIG. 15. The latch mechanisms are engaged to lock the beams in the running position, but the stand is left in its retracted position so that the gooseneck and trailer deck can swing up and down relative to the pulling vehicle as the rig travels over surfaces that are not entirely flat.

The invention has a number of important features and advantages. The hydraulically operated gooseneck assembly allows the gooseneck to be connected to and disconnected from the trailer deck without ever having to disconnect the gooseneck from the fifth wheel of the pulling vehicles. The latch mechanisms lock the gooseneck securely and safely in its different operating positions, and the wide gooseneck enhances the stability and safety of the trailer.

It is apparent from the foregoing that a new and improved hydraulically operated gooseneck trailer and latch assembly has been provided. While only certain presently preferred embodiments have been described in detail, as will be apparent to those familiar with the art, certain changes and modifications can be made without departing from the scope of the invention as defined by the following claims.

1. A gooseneck trailer comprising an elongated deck supported toward its rear by ground engaging wheels, upper and lower gooseneck beams connected pivotally together for connecting the deck to a towing vehicle, a hydraulic cylinder for moving the beams to different positions, first and second elongated ratchet blocks disposed side-by-side with mating teeth along confronting edges of the two blocks and upper and lower ends of the blocks being pivotally connected to respective ones of the beams for movement longitudinally with the beams and laterally toward and away from each other, and actuators for pivoting the blocks to bring the teeth on the two blocks into and out of engagement with each other to lock the beams in the different positions.

2. The gooseneck trailer of claim 1 wherein the ratchet blocks are disposed in an elongated housing having opposing side walls generally parallel to the edges of the blocks with the teeth, and the actuators comprise operating cylinders connected to the ratchet blocks and push bars connected to the operating cylinders for bearing against the opposing side walls to bring the teeth into and out of engagement with each other.

3. The gooseneck trailer of claim 2 wherein the bodies of the operating cylinders are connected to the ratchet blocks and the armatures are connected to the push bars, with opposite ends of the push bars bearing against opposite ones of the side walls when the armatures are in extended and retracted positions.

4. The gooseneck trailer of claim 3 wherein the push bars are generally U-shaped, with base sections attached to the armatures and arms which extend from the base sections along opposite sides of the ratchet blocks.

5. The gooseneck trailer of claim 1 wherein the housing has telescoping sections connected to the ratchet blocks for extension and retraction as the blocks move with the beams.

6. The gooseneck assembly of claim 1 including a stand engagable with the pulling vehicle for supporting the upper beam in a predetermined position when the lower beam is disconnected from the trailer.

7. The gooseneck assembly of claim 1 wherein the deck has a plurality of longitudinally extending frame members including outer side rails which extend along opposite sides of the deck, and the lower gooseneck beams are connected the outer deck rails

8. A gooseneck trailer comprising a horizontally extending deck having a plurality of longitudinally extending frame members including outer side rails which extend along opposite sides of the deck, lower gooseneck beams rigidly connected the outer deck rails by couplings that can be selectively engaged and disengaged, elongated upper gooseneck beams pivotally connected to the lower beams, with one end of each of the upper beams being pivotally connected to a pulling vehicle, operating cylinders connected between the upper and lower beams for raising and lowering the lower beams and the trailer deck when the upper beams are connected to the pulling vehicle, and latches for locking the upper and lower beams in different positions relative to each other.

9. The gooseneck assembly of claim 8 wherein each of the latches comprises first and second elongated ratchet blocks disposed side-by-side with mating teeth along confronting edges of the two blocks, one end of the first block being pivotally connected to the upper beam for movement about a first axis and the opposite end of the second block being pivotally connected to the lower beam for movement about a second axis substantially parallel to the first axis, and actuators for pivoting the blocks about the first and second axes to bring the teeth on the two blocks into and out of engagement with each other.

10. The gooseneck assembly of claim 8 including a stand engagable with the pulling vehicle for supporting the upper beams in a predetermined position when the lower beams are disconnected from the trailer.

11. A gooseneck assembly for connecting a trailer to a pulling vehicle, comprising: a lower beam having a downwardly facing mounting surface for engagement with an upwardly facing mounting surface at the front of the trailer, a coupling for locking the lower beam rigidly to the trailer with the mounting surfaces in abutting engagement with each other, an upper beam with a free end that is connected to the pulling vehicle in a manner permitting the upper beam to pivot about a first horizontal axis, a pivotal connection between the upper beam and the lower beam permitting relative movement of the upper beam and the lower beam about a second horizontal axis, and a hydraulic operating cylinder connected between the upper beam and the lower beam for rotating the beams about the axes to raise and lower the front of the trailer.

12. The gooseneck assembly of claim 11 including a latch for locking the upper beam and the lower beam in different rotational positions relative to each other.

13. The gooseneck assembly of claim 12 wherein the latch comprises first and second elongated ratchet blocks disposed side-by-side with mating teeth along confronting edges of the two blocks, one end of the first block being pivotally connected to the upper beam for movement about a first axis and the opposite end of the second block being pivotally connected to the lower beam for movement about a second axis substantially parallel to the first axis, and actuators for pivoting the blocks about the first and second axes to bring the teeth on the two blocks into and out of engagement with each other.

14. The gooseneck assembly of claim 11 including a stand engagable with the pulling vehicle for supporting the upper beam in a predetermined position when the lower beam is disconnected from the trailer.
